(19) United States
(12) Patent Application Publication
(10) Pub. No.: US 2005/0036083 A1
(43) Pub. Date: Feb. 17, 2005

(54) Optical member, method for manufacturing the same, surface emitting device, and liquid crystal display device

(75) Inventors: Yuzo Hayashi, Fukushima-ken (JP); Mitsuo Ohizumi, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/911,880

(22) Filed: Aug. 5, 2004

(30) Foreign Application Priority Data
Aug. 14, 2003 (JP) 2003-293443

(51) Int. Cl. G02F 1/1335

(52) U.S. Cl. 349/63

(57) ABSTRACT

An optical member includes a composite including a transparent resin film and an UV-cured resin layer. The optical member may have a light guide plate portion and a light guide bar portion with a slit therebetween. For manufacturing an optical member, an UV-curable resin composition is applied onto a surface of a transparent resin film. The UV-curable resin composition is pressed with a transfer roller having a molding surface at the periphery. The pressed UV-curable resin composition is exposed to ultraviolet light to be cured.

### BACKGROUND OF THE INVENTION

1. Field of the Invention

The present invention relates to an optical member used for a surface emitting device of liquid crystal display devices or the like and a method for manufacturing the optical member. The present invention also relates to a surface emitting device and a liquid crystal display device including the optical member.

2. Description of the Related Art

Some of the recently developed display devices displaying images by use of external light reflection, such as reflective liquid crystal display (LCD) devices, have a surface emitting device (front light) on their front side, so that the display device can be used in such a dark place that sufficient amount of external light is not provided. The surface emitting device includes a light emitting diode (LED), a light guide bar, and a light guide plate, as described in Japanese Unexamined Patent Application Publication Nos. 2001-195915 and 2001-141931.

FIG. 16 is a schematic perspective view of a liquid crystal display device including a surface emitting device. In FIG. 16, the surface emitting device 110 is disposed at the front side (upper surface side) of a liquid crystal panel 120 so as to illuminate the liquid crystal panel 120 from the front side, and mainly includes a light guide plate 112, a light guide bar 113, and a light source 115.

The light source 115 is integrated with the light guide bar 113 provided at an edge of an end of the light guide plate 112 into a light source unit with a large width for emitting widely spread light toward the end surface of the light guide plate 112.

The light guide plate 112, which has an area as large as the display area of the liquid crystal panel 120, comprises a plate formed by injection molding of a transparent acrylic resin or the like, and disposed parallel to the displaying surface of the liquid crystal panel 120.

The front surface 112c of the light guide plate 112 has ridges 114 for changing the direction of light propagating through the light guide plate 112. The ridges 114 each have a triangular shape when view from a side, and lie parallel to each other to form prism-shaped faces.

The light guide bar 113 is joined to an end surface of the light guide plate 112 along the edge of the end surface, and the light source 115 is joined to an end of the light guide bar 113. Although the light guide bar 113 has only one light source 115 at its end in the example shown in the figure, two light sources may be provided at both ends of the light guide bar 113. The outer side surface 113a (opposite the light guide plate 112) of the light guide bar 113 has prism-shaped grooves, not shown in the figure, for reflecting light propagating through the light guide bar 113 to change the propagating direction of the light.

The light source 115 is used as a point source for LEDs, organic electroluminescence (EL) devices, and other optical devices, and is disposed so that the light-emitting direction of the light source 115 points toward the side surface of the light guide bar 113.

FIG. 17 shows how light travels in the liquid crystal display device 100. As shown in FIG. 17, light emitted from the light source 115 enters the light guide bar 113 from an end of the light guide bar 113. The light is reflected at a reflector 116 to change the propagation direction, thus entering the light guide plate 112 through the side surface 112a of the light guide plate 112. The light propagating through the light guide plate 112 is reflected at the prism surfaces of the ridges 114 to change the propagation direction, and is thus emitted from the emitting surface (lower surface) of the light guide plate 112 to the liquid crystal panel 120. Thus, the light illuminates the liquid crystal panel 120 disposed at the back (lower side in the figure) of the surface emitting device 110.

The liquid crystal panel 120 underlies the light guide plate 112. The liquid crystal panel 120 includes a liquid crystal layer 31 lying between a first substrate 34 and a second substrate 35. The first substrate 34 and the second substrates 35 are opposed to each other and bonded together with a sealant 36. The surface of the first substrate 34 opposing the liquid crystal layer 31 has a circuit board 39 for drive-controlling the liquid crystal layer 31, including an electrode layer and an alignment layer. On the surface of the second substrate 35 opposing the liquid crystal layer 31, a reflection layer 37 and a circuit board 38 including an electrode layer and an alignment layer are deposited in that order. The reflection layer 37 reflects light coming into the liquid crystal panel 120, and the circuit board 38 drive-controls the liquid crystal layer 31. The reflection layer 37 may have a rough surface to diffuse the reflected light.

In FIG. 17, the light source 115 is joined with the end of the light guide bar 113 in such a manner as to overlie the light guide bar 113 on the sheet of the figure.

In the above-described structure, the light guide bar 113 helps light to enter the light guide plate 112 from its entire side surface joined with the light guide bar 113, thus improving the uniformity of light from the emitting surface of the light guide plate 112.

The liquid crystal panel 120 and the surface emitting device 110 including the above-described light source unit are housed in a molded case together with other components to constitute a liquid crystal display device.

The light guide plate 112 is preferably formed by injection molding. Specifically, as shown in FIG. 18, a heat-resistant transparent resin is injected into a cavity 203 defined by an upper mold 201 and a lower mold 202, and is cooled to cure. Then, the upper mold 201 and the lower mold 202 are separated to take out the light guide plate 112. Since the gentle slopes 114a and steep slopes 114b of the ridges 114 each face toward the upper mold 201 and the angles defining the apexes of the ridges are as obtuse as 90° or more, the light guide plate 112 can be easily removed from the upper mold 201 without interference between the ridges 114 and the molding surface 204 of the upper mold 201.

However, such a manufacturing process of the light guide plate requires a series of steps of: injecting the resin into the cavity 203; cooling the resin to cure; and separating the upper mold 201 and the lower mold 202. Therefore, the process does not allow the light guide plate 112 to be manufactured through a continuous step. Thus, the process is not suitable for mass-production and it is difficult to reduce costs.

Furthermore, the process limits the thickness of the light guide, and it is difficult to provide at a low cost a light guide plate having a thickness as small as 1 mm or less in response to a demand for small-thickness apparatus.

### SUMMARY OF THE INVENTION

In view of the foregoing disadvantages in the known art, an object of the present invention is to provide an optical member used as a thin light guide plate adaptable to thin apparatus at low cost and a manufacturing process suitable for mass production. Another object of the present invention is to provide a surface emitting device and a liquid crystal display device using the optical member as the light guide plate.

According to an aspect of the present invention, an optical member is provided which comprises a composite including a transparent resin film and an UV-cured resin layer. The UV-cured resin layer has first ridges with triangular sections at the surface.

This structure can provide an optical member with a small thickness having characteristics suitable for a light guide plate. In addition, the structure makes possible a continuous process of the optical member and, thus, mass production at low cost.

The present invention is also directed to another optical member comprising a composite including a transparent resin film and an UV-cured resin layer. The composite has a portion having first ridges with triangular sections at the surface of the UV-cured resin layer and a portion where the surface of the UV-cured resin layer is flat.

The optical member having such a structure advantageously includes an equivalent of the light guide bar to which a light source is joined.

The present invention is also directed to another optical member comprising a composite including a transparent resin film and an UV-cured resin layer. The composite has a portion having first ridges with triangular sections at the surface of the UV-cured resin layer and a portion having second ridges with triangular sections smaller than the sections of the first ridges at the surface of the UV-cured resin layer. The second ridges extend in a direction of about 45° with respect to the direction in which the first ridges extend.

This structure can help introduce light efficiently into the optical member proper when a point light source is provided at a side surface of the optical member. Thus, the resulting optical member can be advantageously applied to a surface emitting device.

The present invention is also directed to another optical member comprising a composite including a transparent resin film and an UV-cured resin layer. The composite has a portion having first ridges with triangular sections at the surface of the UV-cured resin layer and a portion having second ridges with triangular sections smaller than the sections of the first ridges at both the surface of the UV-cured resin layer and the rear surface of the transparent resin film, wherein the second ridges have an identical shape and extend in an identical direction of 45° with respect to the direction in which the first ridges extend.

The present invention is also directed to another optical member comprising a composite including a transparent resin film and an UV-cured resin layer. The composite has a portion having first ridges with triangular sections at the surface of the UV-cured resin layer; and a portion having second ridges with triangular sections smaller than the sections of the first ridges at both the surface of the UV-cured resin layer and the rear surface of the transparent resin film and a back prism with a triangular section at an end surface of the composite. The second ridges have an identical shape and extending in an identical direction of about 45° with respect to the direction in which the first ridges extend, and the back prism is formed by working the composite in the direction perpendicular to the surface of the composite.

These structures help introduce light more efficiently from a light source into the optical member proper.

In the optical member of the present invention, a slit may be provided in the UV-cured resin layer between the two portions.

By providing such a small air space, light can be efficiently introduced from the portion having the flat surface or the small ridges into the portion having the other ridges.

Preferably, the refractive index of the UV-cured resin layer substantially the same as that of the transparent resin film. In this instance, the refractive index is preferably in the range of 1.4 to 1.6.

This is because such materials can be inexpensive and make it easy to design the optical member for changing the traveling direction of light.

Preferably, the first ridges each have a gentle slope at an angle in the range of 1° to 3° with respect to a horizontal reference plane and a steep slop at an angle in the range of 40° to 45° with respect to the horizontal reference plane, and the first ridges are disposed at a pitch in the range of 100 to 300 μm.

Consequently, light can be efficiently conducted to a liquid crystal panel side.

Preferably, the transparent resin film 2 has a thickness in the range of about 0.15 to 0.3 mm, and the UV-cured resin layer 3 has a thickness in the range of about 5 to 10 μm.

Thus, the thickness of the light guide plate can be reduced to respond to a demand for thin apparatus.

The present invention is also directed to a surface emitting device including the above-described optical member having superior optical characteristics as a light guide plate.

The present invention is also directed to a liquid crystal display device including the surface emitting device.

The surface emitting device and liquid crystal display device of the present invention each include the novel optical member having superior optical characteristics as a light guide plate, and accordingly they exhibit superior optical characteristics providing bright uniform images even though the thickness is small. In addition, such devices can be supplied at lower cost than known devices.

For manufacturing an optical member, the present invention provides a method including the steps of: applying an UV-curable resin composition onto a surface of a transparent resin film; pressing the UV-curable resin composition with a transfer roller having a molding surface at the periphery thereof; and exposing the pressed UV-curable resin composition to ultraviolet light to cure the UV-curable resin composition.

The method can continuously produce the optical member, and is accordingly suitable for mass production at low cost.

The present invention is also directed to another method for manufacturing an optical member, including the steps of: applying an UV-curable resin composition onto a surface of a transparent resin film; pressing the UV-curable resin composition with a transfer roller having a molding surface at the periphery thereof; exposing the pressed UV-curable resin composition to ultraviolet light to cure the UV-curable resin composition; and forming a slit in the cured resin.

This method can continuously mass-produce an optical member suitably used for a surface emitting device including a light guide bar portion and a light guide plate portion at low cost.

The present invention is also directed to another method for manufacturing the optical member, including the steps of: applying an UV-curable resin composition onto a surface of a transparent resin film to prepare a composite; pressing the UV-curable resin composition with a transfer roller having a molding surface at the periphery thereof; exposing the pressed UV-curable resin composition to ultraviolet light to cure the UV-curable resin composition; and forming a back prism having a triangular section at an end surface of the composite by working the composite in the direction perpendicular to the surface of the composite.

This method can continuously mass-produce an optical member whose light guide bar portion efficiently reflects light, at low cost.

The present invention achieves a surface emitting device having superior illumination efficiency in spite of a small thickness. A liquid crystal display device including the surface emitting device can produce high quality images.

In the present invention, a roller having a mold with a predetermined shape on its periphery is used for forming a finely patterned indented surface. Thus, an optical member can be provided at low cost.

In addition, once the shape defined by a gentle slope and a steep slope is set, the occurrence of moire can be prevented by resetting the direction in which an object is worked or cut, even if the pitch of the pixels of a liquid crystal panel is varied. Thus, the method of the present invention can provide a versatile optical member.

Furthermore, inexpensive sheet-like optical members can be continuously manufactured without using an expensive metallic mold. Thus, the present invention provides an optical member with high productivity at low cost.

### BRIEF DESCRIPTION OF THE DRAWINGS

FIG. 1 is a sectional view of an optical member according to a first embodiment of the present invention;

FIG. 2 is a sectional view of a liquid crystal display device according to the present invention;

FIG. 3 is a schematic illustration showing a method for manufacturing the optical member according to the first embodiment of the present invention;

FIG. 4 is a sectional view of a molding surface used in the present invention;

FIG. 5 is a sectional view of a transfer roller used in the present invention;

FIG. 6 is a perspective view of the transfer roller used in the present invention;

FIG. 7 is a schematic illustration showing main parts of a method for manufacturing an optical member according to the present invention;

FIG. 8 is a plan view of an optical member according to a second embodiment of the present invention;

FIG. 9 is a sectional view of the optical member shown in FIG. 8, taken along line IX-IX;

FIG. 10 is a sectional view of a molding surface used for manufacturing the optical member according to the second embodiment of the present invention;

FIG. 11 is a sectional view of a transfer roller used for manufacturing the optical member according to the second embodiment of the present invention;

FIG. 12 is a plan view of an optical member according to a third embodiment of the present invention;

FIG. 13 is a sectional view of the optical member shown in FIG. 12, taken along line XIII-XIII;

FIG. 14 is a plane view of an optical member according to a fourth embodiment of the present invention;

FIG. 15 is a fragmentary enlarged plan view of a back prism;

FIG. 16 is a schematic illustration of a known liquid crystal display device;

FIG. 17 is a sectional view of a known liquid crystal display device; and

FIG. 18 is a schematic illustration showing a method for manufacturing a known light guide plate.

### DESCRIPTION OF THE PREFERRED EMBODIMENTS

First Embodiment

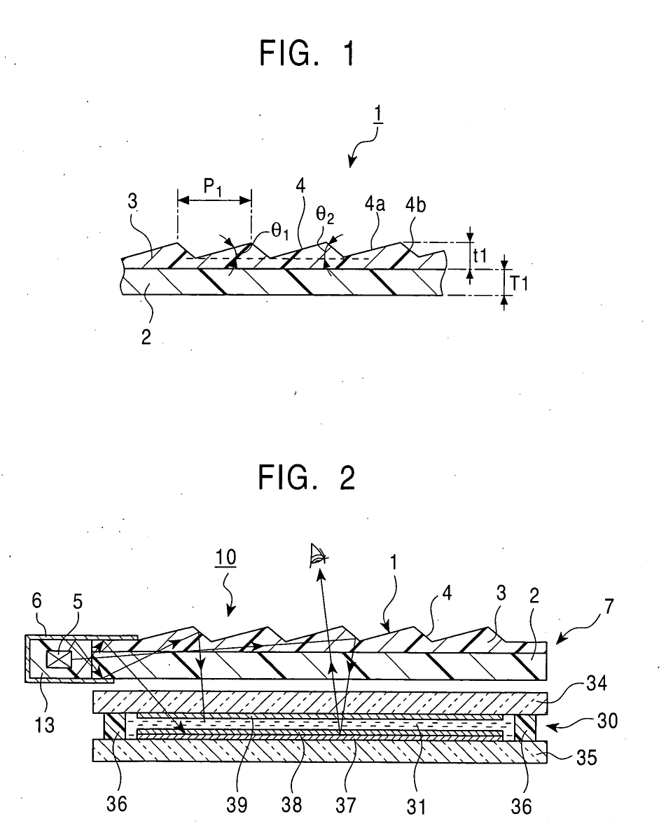

FIG. 1 is a sectional view of an optical member 1 according to a first embodiment of the present invention. The optical member comprises a composite including a transparent resin film 2 serving as the substrate and a UV-cured resin layer 3. The surface of the UV-cured resin layer 3 has ridges 4 defined by gentle slopes 4a and steep slopes 4b, extending parallel to each other at a pitch p1 in the direction perpendicular to the sheet of the figure.

The transparent resin film 2 may comprise acrylic or modified acrylic resin, poly(ethylene terephthalate) resin (PET), polycarbonate resin, or epoxy or modified epoxy resin.

The UV-cured resin layer 3 may comprise a photo-curable or UV-curable resin, such as acrylic or modified acrylic resin.

These resins are transparent to light, and have a refractive index in the range of about 1.4 to 1.6. For example, an acrylic resin has a refractive index of about 1.41.

The transparent resin film 2 has a thickness in the range of about 0.15 to 0.3 mm, and the UV-cured resin layer 3 has a thickness in the range of about 5 to 10 μm.

The ridges 4 provided at the surface of the UV-cured resin layer 3 each have a gentle slope 4a at an angle θ1 in the range of 1° to 3° with respect to a reference plane or the surface of the transparent resin film 2 and a steep slope 4b at an angle θ2 in the range of 40° to 45° with respect to the surface of the transparent resin film 2. These slopes 4a and 4b define the ridges 4, and the ridges 4 are disposed parallel to each other at a pitch p1 in the range of 100 to 300 82 m, extending in the direction perpendicular to the sheet of the figure.

By providing such a structure to the optical member 1, light coming from the left in the figure can be reflected in the direction downward in the figure. Since the transparent resin film 2 and the UV-cured resin layer 3 have substantially the same refractive index, the light travels through the optical member 1 depending on the shape of the ridges 4. Hence, use of the optical member 1 as a light guide plate can provide a surface emitting device (front light) having a small thickness and high performance.

FIG. 2 is a sectional view of a liquid crystal display device including a surface emitting device using the optical member 1 of the present invention. The liquid crystal display device 10 includes a liquid crystal panel 30 and the surface emitting device 7 with the optical member 1 of the present invention disposed over the surface of the liquid crystal panel 30. The surface emitting device 7 includes a light guide bar 13 having a light source 5, joining to the left end of the optical member 1 in the figure. The light guide bar 13 is covered with a reflector 6 extending to the optical member 1.

In the liquid crystal display device 10 of the present invention, light emitted from the light source 5 is introduced into the light guide bar 13 through the end surface of the light guide bar 13 and reflected at the reflector 6 to change the propagation direction, and thus entering the UV-cured resin layer 3. The light is further reflected at the ridges 4 to change the propagation direction. Thus, the light is emitted from the emitting surface (lower surface) of the surface emitting device 7 to the liquid crystal panel 30.

The liquid crystal panel 30 underlies the surface emitting device 7. The liquid crystal panel 30 includes a liquid crystal layer 31 lying between a first substrate 34 and a second substrate 35. The first substrate 34 and the second substrates 35 are opposed to each other and bonded together with a sealant 36. The surface of the first substrate 34 opposing the liquid crystal layer 31 has a circuit board 39 for drive-controlling the liquid crystal layer 31, including an electrode layer and an alignment layer. On the surface of the second substrate 35 opposing the liquid crystal layer 31, a reflection layer 37 and a circuit board 38 including an electrode layer and an alignment layer are deposited in that order. The reflection layer 37 reflects light coming into the liquid crystal panel 30, and the circuit board 38 controls the drive of the liquid crystal layer 31.

The surface emitting device 7 including the light source 5 and the liquid crystal panel 30 are housed in a molded case together with other components to constitute a liquid crystal display device 10.

Since, in the liquid crystal display device 10 including the surface emitting device 7 of the present invention, the thickness of the display device is reduced to be smaller than that of the known liquid crystal display device using a conventional light guide plate. In addition, the liquid crystal display device of the present invention can provide images as bright and uniform as those of the known liquid crystal display device.

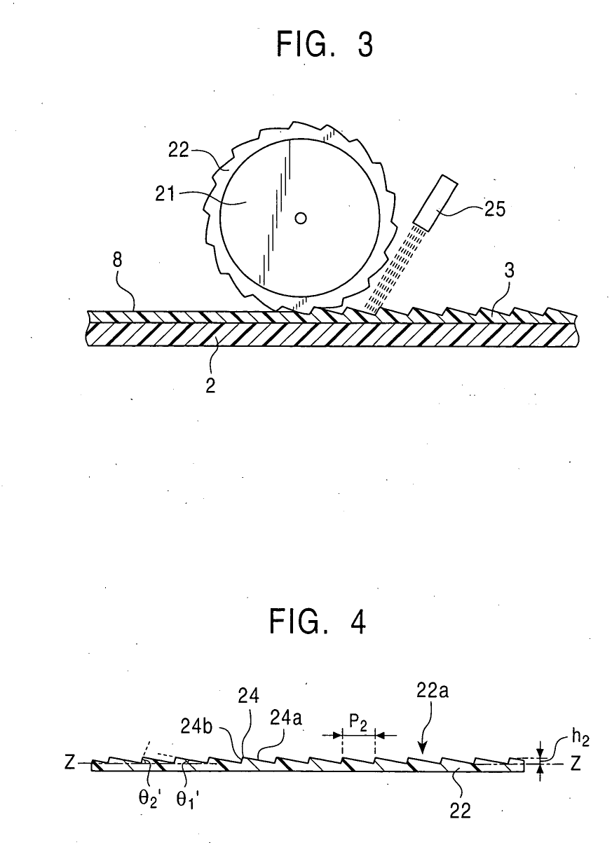

A method for manufacturing the optical member of the present invention will now be described. FIG. 3 is a schematic illustration showing the method for manufacturing the optical member according to the first embodiment. Briefly, the method for manufacturing the optical member includes the steps of: applying an UV-curable resin composition 8 onto the surface of the transparent resin film 2 serving as the substrate; pressing the UV-curable resin composition 8 to form ridges with a transfer roller defined by a roller 21 with a molding surface sheet 22 having a predetermined shape; and exposing the UV-curable resin composition 8 to ultraviolet light from an UV-exposing apparatus 25 to cure the composition.

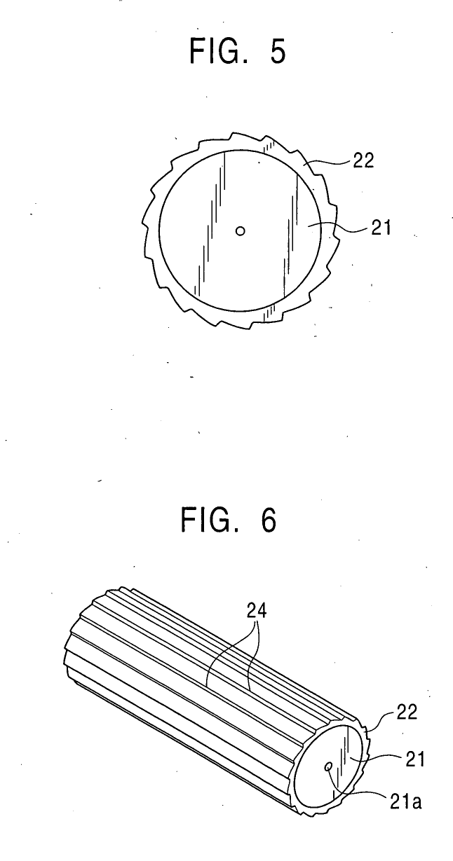

FIG. 4, is a sectional view of the molding surface sheet 22 before putting it on the roller, expanded into a plane. The molding surface sheet 22 before putting on the roller 21 comprises a substantially plane sheet. The length of the molding surface sheet 22 is the same as the circumference of the roller 21, and a necessary transfer pattern for one optical member is formed within the length. The entire surface (upper surface in the figure) or transfer surface 22a of the sheet is provided with a transfer pattern which forms a shape opposite to a desired shape when the sheet is put on the roller 21. The transfer surface 22a has a plurality of ridges 24 disposed adjacent to each other. The ridges 24 are each defined by a gentle slope 24a and a steep slope 24b. The ridge 24 has a triangular longitudinal section. The gentle slope 24a and the steep slope 24b are tilted at angles θ1′ and θ2′ with respect to a horizontal reference plane Z. The tilt angle θ2′ of the steep slope 24b is larger than the tilt angle θ1′ of the gentle slope 24a. The tilt angle θ1′ of the gentle slope 24a is in the range of 0.5° to 5° with respect to the horizontal reference plane Z, and the tilt angle θ2′ of the steep slope 24b is in the range of 40° to 60°. These angles are set according to the diameter of the roller 21, in consideration of the elongation of the molding surface sheet 22 when it is put on the roller 21.

The pitch P₂ of the ridges 24 (intervals between the apexes of the ridges) is substantially constant in the area of the transfer surface 22a, and is set in the range of 100 to 300 μm in consideration of the elongation of the molding surface sheet 22 when it is put on the roller 21.

FIG. 5 is a sectional view of the transfer roller 21. The molding surface sheet 22 is wound around the roller 21 to prepare the transfer roller. The pitch P₂ or the intervals between the ridges 24 of the molding surface sheet 22 is increased to some extent when it is wound around the roller 21. Hence, the angle between the steep slope 24b of a ridge 24 and the gentle slope 24a of the adjacent ridge 24 is increased. Consequently, the UV-cured resin layer 3 formed on the molding surface 22 can be easily removed.

FIG. 6 is a perspective view of the transfer roller. The surface of the roller 21 is wrapped with the molding surface sheet 22 with the ridges 24, and rotates on the central axis 21a of the roller.

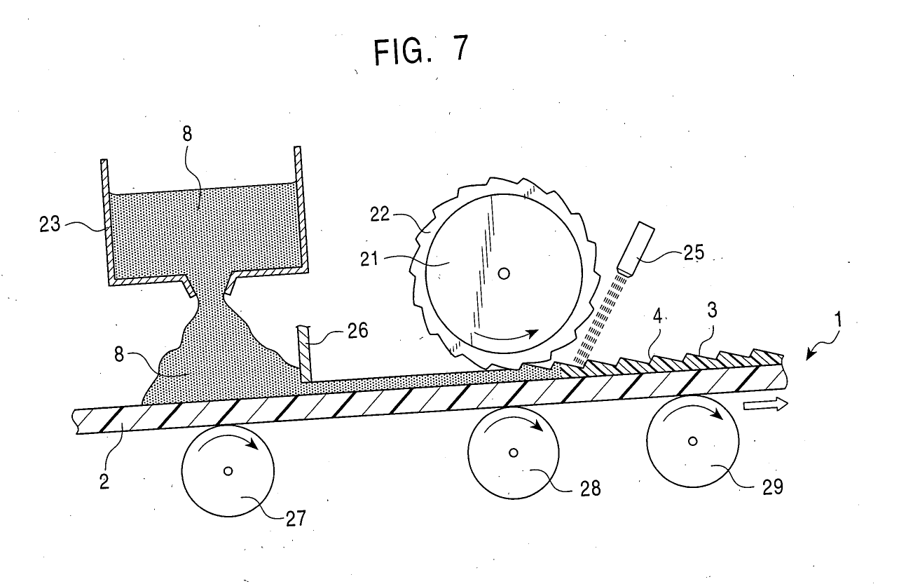

FIG. 7 is a schematic illustration showing main parts of a method for manufacturing an optical member according to the present invention. While the transparent resin film 2 wound around a reel is fed onto support rolls 27, 28, and 29 rightward from the left in the figure, the UV-curable resin composition 8 in a storage tank 23 is discharged onto the transparent resin film 2 and an appropriate amount of the UV-curable resin composition 8 is spread by a scraper 26.

While the transparent resin film 2 is transported rightward, the transfer roller defined by the roller 21 wrapped with the molding surface sheet 22 presses the UV-curable resin composition 8 in such a manner that the transparent resin film 2 is pinched between the transfer roller and the support roller 28. Thus, ridges 4 having triangular sections are formed at the surface of the UV-curable resin composition 8. Then, the ridges 4 of the UV-curable resin composition 8 are exposed to ultraviolet light from an UV exposing apparatus 25 to cure the composition. Thus, the UV-cured resin layer 3 having the ridges 4 is provided over the surface of the transparent resin film 2 to prepare the optical member 1.

This manufacturing method leads to efficient continuous production of the optical member.

Second Embodiment

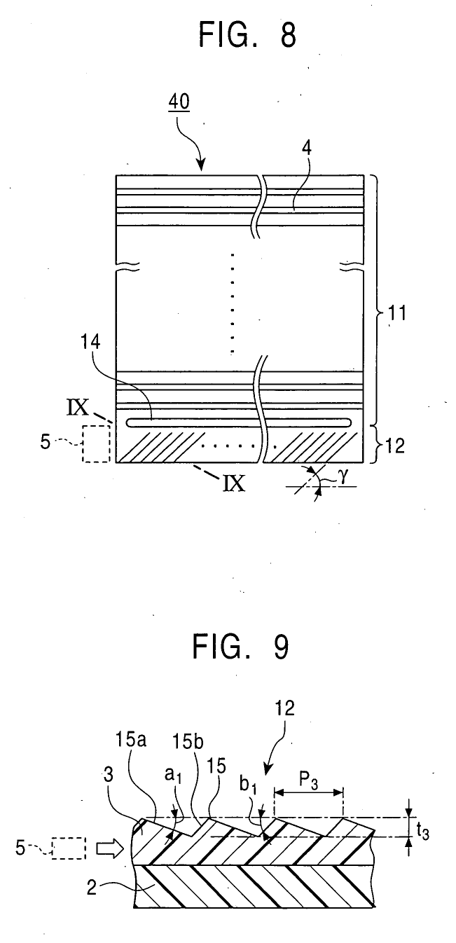

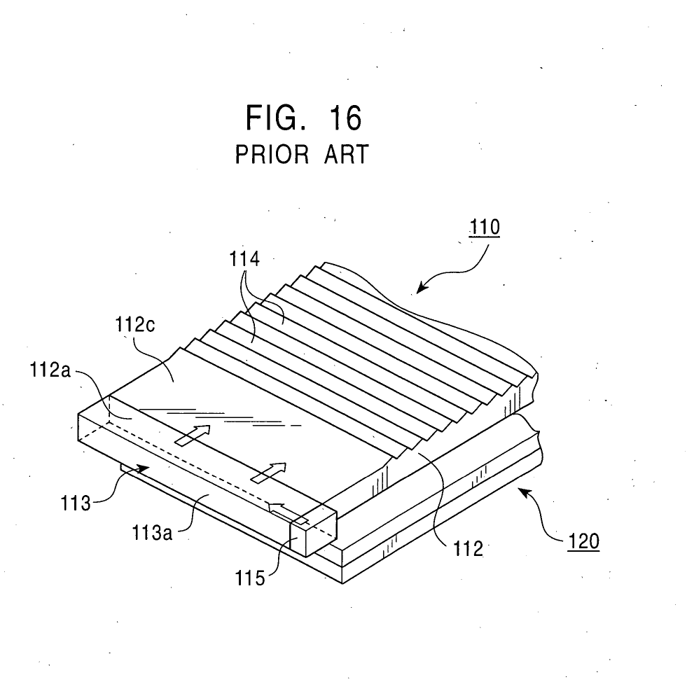

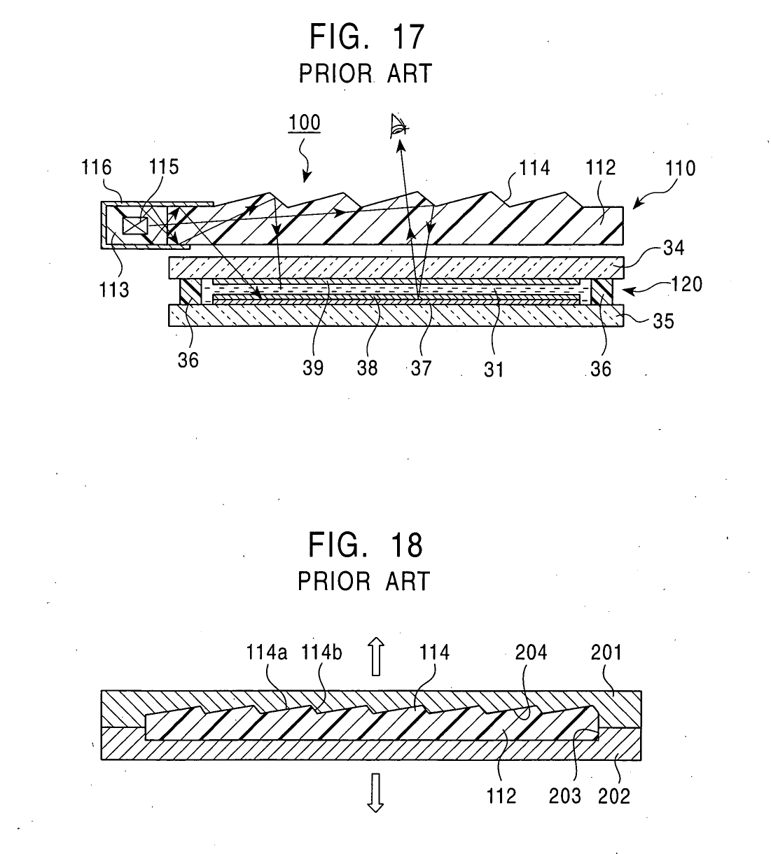

FIG. 8 is a plan view of an optical member according to a second embodiment of the present invention. The optical member 40 of the second embodiment includes a light guide plate portion 11 and a light guide bar portion 12. The functions of these portions are the same as those of the known light guide plate 112 and light guide bar 113 shown in FIGS. 16 and 17, and the description is omitted. The light guide plate portion 11 has the above-described ridges 4 with triangular sections at its surface. In addition, the light guide bar portion 12 has small ridges 15 with triangular sections at its surface. Preferably, the small ridges 15 extend in the direction of about 45°, preferably in the range of 41° to 45°, and more preferably 42° to 44° with respect to the direction in which the ridges 4 of the light guide plate portion 11 extend. The small ridges 15 are intended to reflect light from the light source 5 provided at the left side in the figure to introduce the light into the light guide plate portion 11.

A slit 14 of 200 μm or less in width is formed in the region of the UV-cured resin layer 3 between the light guide plate portion 11 and the light guide bar portion 12. The slit 14 helps light from the light guide bar portion 12 enter the light guide plate portion 11 efficiently. Preferably, the slit 14 is formed perpendicular to the UV-cured resin layer 3.

FIG. 9 shows the section of the optical member shown in FIG. 8 taken along line IX-IX. The section of the small ridges 15 has a gentle slope 15a at an angle al in the range of 25° to 40° with respect to a reference plane or the surface of the transparent resin film 2 and a steep slope 15b at an angle b1 in the range of 40° to 45° with respect to the surface of the transparent resin film 2. The ridges 15 defined by these slopes 4a and 4b are disposed at a pitch P₃ in the range of 0.20 to 0.24 mm with a height t3 in the range of 20 to 200 μm.

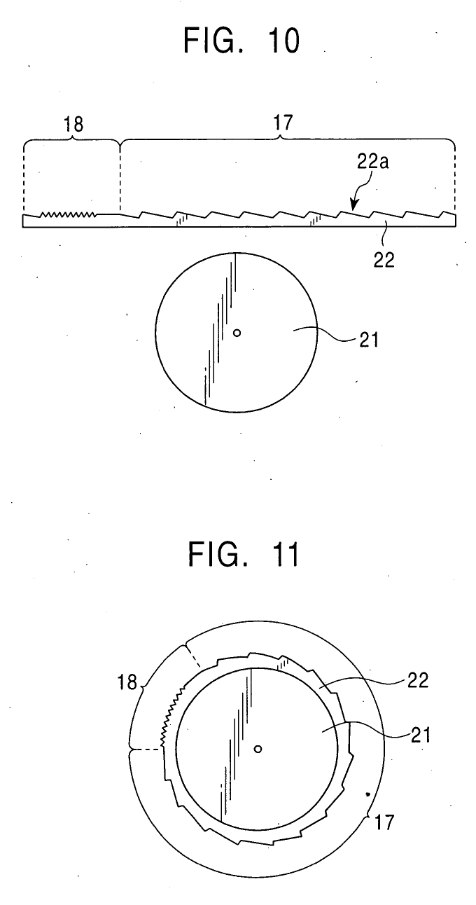

In order to manufacture the optical member 40 of the second embodiment, the molding surface sheet 22 to be wound around the roller 21 has a transfer pattern shown in FIG. 8 in plan view. FIG. 10 shows a section of the transfer pattern used in the manufacturing process of the optical member 40 of the second embodiment. The molding surface sheet 22 used in the second embodiment is different from that of the first embodiment in that it has a light guide plate pattern 17 with ridges for forming the light guide plate portion and a light guide bar pattern 18 with ridges for forming the light guide bar portion. The light guide plate pattern 17 is the same as the transfer pattern of the molding surface sheet of the first embodiment. The light guide bar pattern 18 is formed in a shape reverse to the shape of the small ridges 15.

FIG. 11 is a sectional view of the transfer roller used in the manufacturing process of the optical member 40 of the second embodiment. The molding surface sheet 22 as shown in FIG. 11 is wound around the roller 21. While the resulting transfer roller makes one turn, the light guide plate pattern 17 and the light guide bar pattern 18 press the UV-curable resin.

Third Embodiment

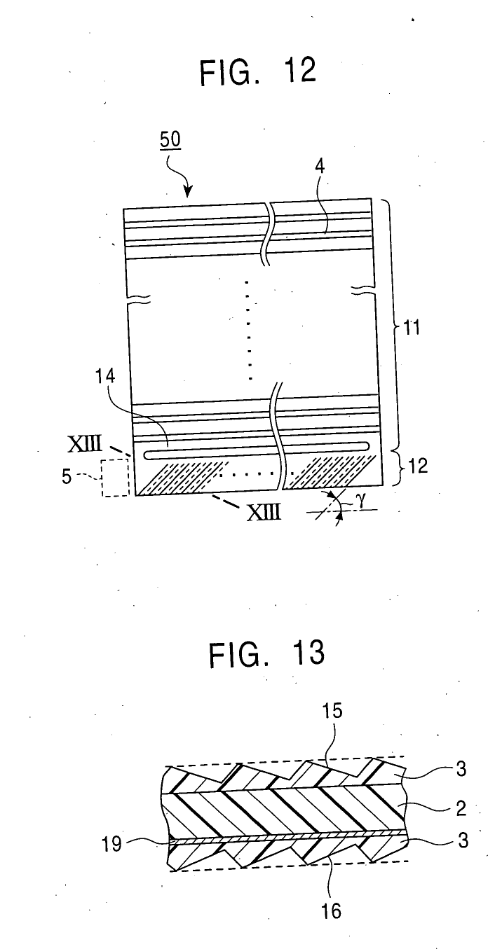

FIG. 12 is a plan view of an optical member 50 according to a third embodiment of the present invention. The third embodiment is different from the second embodiment in that additional small ridges 16 are provided at the rear surface of the light guide bar portion 12. These small ridges 16 have the same shape as the small ridges 15 in the second embodiment shown in FIG. 9. The small ridges 15 and 16 extend in the same direction with respect to the light source 5, as shown in FIG. 12.

FIG. 13 is a sectional view of the optical member 50 shown in FIG. 12, taken along line XIII-XIII. As shown in FIG. 13, the front side (upper side in the figure) of the light guide bar portion 12 has the small ridges 15 formed at the surface of the UV-cured resin layer 3 joined with the transparent resin film 2. On the other side or the rear side (lower surface in the figure) of the light guide bar portion 12, an additional UV-cured resin layer 3 is bonded with an adhesive layer 19. The small ridges 16 are formed in this UV-cured resin layer 3. Hence, the small ridges 16 are formed at the surface of the independently bonded UV-cured resin layer 3.

By providing the small ridges 15 and 16 at both the front surface and the rear surface of the light guide bar portion 12, light can be efficiently introduced into the light guide plate portion 11 from the light source joined to an end surface of the light guide bar portion 12.

Fourth Embodiment

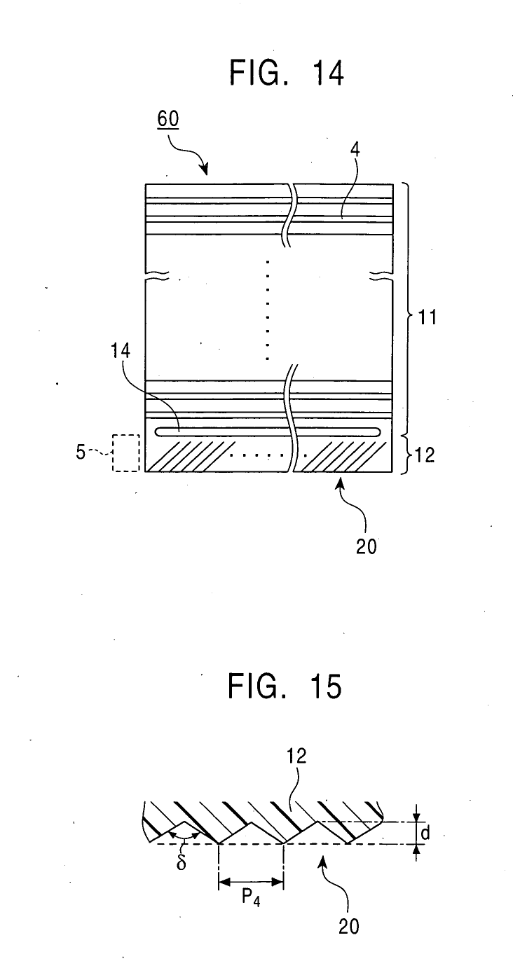

FIG. 14 is a plan view of an optical member 60 according to a fourth embodiment of the present invention. In the fourth embodiment, a back prism 20 having a prism-shaped section is provided at the side surface of the light guide bar portion 12. The light guide plate portion 11 has the same structure as in the second and third embodiments. The slit 14 is also provided as in the foregoing embodiments.

FIG. 5 is a fragmentary enlarged plan view of the back prism 20 shown in FIG. 14.

Preferably, the back prism 20 has an opening angle δ in the range of 105° to 115°, a depth d in the range of 10 to 70 μm, and a pitch P₄ in the range of 0.2 to 0.24 mm.

The depth d and pitch P₄ of the back prism 20 are appropriately set according to the distance from the light source. For example, as the distance increases, the pitch P₄ is reduced and the depth d is increased. Thus, the luminance distribution of light emitted in the longitudinal direction of the light guide bar portion 12 can be uniformized to provide good characteristics to the resulting surface emitting device.

The back prism 20 is formed by working the UV-cured resin layer of the light guide bar portion 12 in the direction substantially perpendicular to the layer. The back prism 20 may be formed simultaneously with the formation of the slit by laser beam cutting. Alternatively, a mold having a pattern corresponding to the shape of the back prism may be prepared in advance, and a plurality of the optical members lying on top of one another may be heated and pressed with the mold to form the back prism. Such a process can efficiently manufacture many optical members.

While the above-described embodiments illustrate liquid crystal panels having a surface emitting device at their front (viewing side), the optical member of the present invention may be disposed at the back (opposite the viewing side) of a liquid crystal panel to provide a backlight-type device.

1. An optical member comprising a composite including: a transparent resin film; and an UV-cured resin layer having first ridges at a surface thereof, the ridges having triangular sections.

2. An optical member comprising a composite including a transparent resin film and an UV-cured resin layer, the composite having a portion having first ridges with triangular sections at a surface of the UV-cured resin layer and a portion where the surface of the UV-cured resin layer is flat.

3. An optical member comprising a composite including a transparent resin film and an UV-cured resin layer, the composite having a portion having a first ridges with triangular sections at a surface of the UV-cured resin layer and a portion having second ridges with triangular sections smaller than the sections of the first ridges at the surface of the UV-cured resin layer, wherein the second ridges extend in a direction of about 45° with respect to a direction in which the first ridges extend.

4. An optical member comprising a composite including a transparent resin film and an UV-cured resin layer, the composite having a portion having first ridges with triangular sections at a surface of the UV-cured resin layer and a portion having second ridges with triangular sections smaller than the sections of the first ridges at both the surface of the UV-cured resin layer and a rear surface of the transparent resin film, wherein the second ridges have an identical shape and extend in an identical direction of 45° with respect to a direction in which the first ridges extend.

5. An optical member comprising a composite including a transparent resin film and an UV-cured resin layer, the composite having: a portion having first ridges with triangular sections at a surface of the UV-cured resin layer; and a portion having second ridges with triangular sections smaller than the sections of the first ridges at both the surface of the UV-cured resin layer and a rear surface of the transparent resin film and a back prism with a triangular section at an end surface of the composite, wherein the second ridges have an identical shape and extend in an identical direction of about 45° with respect to a direction in which the first ridges extend, and the back prism is formed by working the composite in a direction perpendicular to a surface of the composite.

6. The optical member according to claim 2, wherein a slit is provided in the UV-cured resin layer between the two portions.

7. The optical member according to claim 1, wherein a refractive index of the UV-cured resin layer is substantially the same as a refractive index of the transparent resin film.

8. The optical member according to claim 1, wherein refractive indexes of the transparent resin film and the UV-cured resin layer are in the range of 1.4 to 1.6.

9. The optical member according to claim 1, wherein the first ridges each have a gentle slope at an angle in the range of 1° to 3° with respect to a horizontal reference plane and a steep slop at an angle in the range of 40° to 45° with respect to the horizontal reference plane, and the first ridges are disposed at a pitch in the range of 100 to 300 μm.

10. The optical member according to claim 1, wherein the transparent resin film has a thickness in the range of 0.15 to 0.3 mm, and the UV-cured resin layer has a thickness in the range of 5 to 10 μm.

11. A surface emitting device comprising the optical member as set forth in claim 1.

12. A liquid crystal display device including a surface emitting device including the optical member as set forth in claim 1.

13. A method for manufacturing an optical member comprising the steps of:
applying an UV-curable resin composition onto a surface of a transparent resin film;
pressing the UV-curable resin composition with a transfer roller having a molding surface at a periphery thereof; and
exposing the pressed UV-curable resin composition to ultraviolet light to cure the UV-curable resin composition.

14. A method for manufacturing an optical member comprising the steps of:
applying an UV-curable resin composition onto a surface of a transparent resin film;
pressing the UV-curable resin composition with a transfer roller having a molding surface at a periphery thereof;
exposing the pressed UV-curable resin composition to ultraviolet light to cure the UV-curable resin composition; and
forming a slit in the cured resin.

15. A method for manufacturing an optical member comprising the steps of:
applying an UV-curable resin composition onto a surface of a transparent resin film to prepare a composite;
pressing the UV-curable resin composition with a transfer roller having a molding surface at a periphery thereof;
exposing the pressed UV-curable resin composition to ultraviolet light to cure the UV-curable resin composition; and
forming a back prism having a triangular section at an end surface of the composite by working the composite in a direction perpendicular to the surface of the composite.

16. The optical member according to claim 2, wherein a refractive index of the UV-cured resin layer is substantially the same as a refractive index of the transparent resin film.

17. The optical member according to claim 2, wherein refractive indexes of the transparent resin film and the UV-cured resin layer are in the range of 1.4 to 1.6.

18. The optical member according to claim 2, wherein the first ridges each have a gentle slope at an angle in the range of 1° to 3° with respect to a horizontal reference plane and a steep slop at an angle in the range of 40° to 45° with respect to the horizontal reference plane, and the first ridges are disposed at a pitch in the range of 100 to 300 μm.

19. The optical member according to claim 2, wherein the transparent resin film has a thickness in the range of 0.15 to 0.3 mm, and the UV-cured resin layer has a thickness in the range of 5 to 10 μm.

20. A surface emitting device comprising the optical member as set forth in claim 2.

21. A liquid crystal display device including a surface emitting device including the optical member as set forth in claim 2.

22. The optical member according to claim 3, wherein a slit is provided in the UV-cured resin layer between the two portions.

23. The optical member according to claim 3, wherein a refractive index of the UV-cured resin layer is substantially the same as a refractive index of the transparent resin film.

24. The optical member according to claim 3, wherein refractive indexes of the transparent resin film and the UV-cured resin layer are in the range of 1.4 to 1.6.

25. The optical member according to claim 3, wherein the first ridges each have a gentle slope at an angle in the range of 1° to 3° with respect to a horizontal reference plane and a steep slop at an angle in the range of 40° to 45° with respect to the horizontal reference plane, and the first ridges are disposed at a pitch in the range of 100 to 300 μm.

26. The optical member according to claim 3, wherein the transparent resin film has a thickness in the range of 0.15 to 0.3 mm, and the UV-cured resin layer has a thickness in the range of 5 to 10 μm.

27. A surface emitting device comprising the optical member as set forth in claim 3.

28. A liquid crystal display device including a surface emitting device including the optical member as set forth in claim 3.

29. The optical member according to claim 4, wherein a slit is provided in the UV-cured resin layer between the two portions.

30. The optical member according to claim 4, wherein a refractive index of the UV-cured resin layer is substantially the same as a refractive index of the transparent resin film.

31. The optical member according to claim 4, wherein refractive indexes of the transparent resin film and the UV-cured resin layer are in the range of 1.4 to 1.6.

32. The optical member according to claim 4, wherein the first ridges each have a gentle slope at an angle in the range of 1° to 3° with respect to a horizontal reference plane and a steep slop at an angle in the range of 40° to 45° with respect to the horizontal reference plane, and the first ridges are disposed at a pitch in the range of 100 to 300 μm.

33. The optical member according to claim 4, wherein the transparent resin film has a thickness in the range of 0.15 to 0.3 mm, and the UV-cured resin layer has a thickness in the range of 5 to 10 μm.

34. A surface emitting device comprising the optical member as set forth in claim 4.

35. A liquid crystal display device including a surface emitting device including the optical member as set forth in claim 4.

36. The optical member according to claim 5, wherein a slit is provided in the UV-cured resin layer between the two portions.

37. The optical member according to claim 5, wherein a refractive index of the UV-cured resin layer is substantially the same as a refractive index of the transparent resin film.

38. The optical member according to claim 5, wherein refractive indexes of the transparent resin film and the UV-cured resin layer are in the range of 1.4 to 1.6.

39. The optical member according to claim 5, wherein the first ridges each have a gentle slope at an angle in the range of 1° to 3° with respect to a horizontal reference plane and a steep slop at an angle in the range of 40° to 45° with respect to the horizontal reference plane, and the first ridges are disposed at a pitch in the range of 100 to 300 μm.

40. The optical member according to claim 5, wherein the transparent resin film has a thickness in the range of 0.15 to 0.3 mm, and the UV-cured resin layer has a thickness in the range of 5 to 10 μm.

41. A surface emitting device comprising the optical member as set forth in claim 5.

42. A liquid crystal display device including a surface emitting device including the optical member as set forth in claim 5.
